(19) United States
(12) Patent Application Publication
(10) Pub. No.: US 2024/0229912 A1
(43) Pub. Date: Jul. 11, 2024

(54) DRIVE DEVICE FOR A VEHICLE AXLE

(71) Applicant: AUDI AG, Ingolstadt (DE)

(72) Inventor: Harald GLOEDE, Pförring (DE)

(73) Assignee: AUDI AG, Ingolstadt (DE)

(21) Appl. No.: 18/561,604

(22) PCT Filed: May 4, 2022
(86) PCT No.: PCT/EP2022/062060

§ 371 Date: Nov. 16, 2023

(30) Foreign Application Priority Data
May 19, 2021 (DE) 10 2021 112 973.7

(51) Int. Cl. F16H 57/02; B60K 1/00

(52) U.S. Cl. CPC F16H 57/02; B60K 1/00; B60K 2001/001; F16H 2057/02008; F16H 2057/02034; F16H 2057/02052

(57) ABSTRACT

A drive device for a vehicle axle of a vehicle, having an electric machine (EM) which outputs to output shafts via a gearbox. The output shafts each lead to a vehicle wheel, wherein a cylindrical stator housing of the electric machine (EM) is elongated in the axial direction by a gearbox housing. In an example, at least one screw point between a stator housing and a gearbox housing has a threaded bolt, which is guided through a non-threaded screw hole of the gearbox housing and is in threaded engagement with an internally threaded bore formed on the stator housing.

### CROSS-REFERENCE TO RELATED APPLICATIONS

This application is a U.S. national stage of International Application No. PCT/EP2022/062060, filed on May 4, 2022, which claims the priority benefit of German Patent Application No. 10 2021 112 973.7 filed on May 19, 2021. Both the International Application and the German Patent Application are incorporated by reference herein in their entirety.

### BACKGROUND

### 1. Field

The examples of an invention in the present disclosure relate to a drive device for a vehicle axle of a two-track vehicle according to the precharacterizing clause of claim 8 and a method for assembling such a drive device, in an example, according to claim 13.

### 2. Description of the Related Art

An electrified vehicle axle for a two-track motor vehicle has an electric machine which outputs to output shafts via a gearbox and via an axle differential, which output shafts each lead to a vehicle wheel.

In a generic drive device, a cylindrical stator housing of the electric machine is elongated in the axial direction by a gearbox housing, and these are screwed together at a joining plane. A stator-housing side crosses over into a gearbox-housing side at the joining plane. The screw axis at the screw point is aligned axially parallel to the stator-housing axis.

In a comparative example which is not comprised by the examples of the present disclosure, the screw point is realized as follows: A threaded bolt of the screw point is guided through a non-threaded screw hole of the stator housing and into threaded engagement with an internally threaded bore formed on the gearbox housing, so that an opening edge region of the stator-housing screw hole is braced between a bolt head of the threaded bolt and the gearbox housing. In the prior art, this results in the following assembly process: Firstly, in a providing process step, a still empty stator housing is provided and equipped with electric-machine components. The stator-housing axis here is aligned in the vertical processing direction such that the joining face for connection to the gearbox housing is positioned on the stator-housing upper side. An upending process step then takes place, in which the equipped stator housing is upended 180°. The upended stator housing, in a feed process step, is then placed on the gearbox housing in a vertical feed motion from above. At the end of the process, a screw process step is carried out, in which the threaded bolt is screwed into the screw point between the stator housing and the gearbox housing in a vertical joining direction from above.

In the above comparative example, the bolt head of the threaded bolt, i.e. the tool application point, is located on the stator-housing side (i.e. directly laterally adjacent to the outer circumference of the stator housing). Due to the restricted spatial conditions, the tool is not able to access the bolt head without being hampered by interfering contours. Moreover, in the assembly process, an upending process involving complex manufacturing and mounting techniques needs to be carried out so that an inverted screw connection, i.e. a screw connection in a joining direction from below, may be avoided.

An actuator for coupling to the setting shaft of an internal combustion engine to adjust the expansion stroke is known from DE 10 2015 112 684 A1. An electric drive unit for vehicles is known from DE 10 2019 133 843 A1. A gearbox is known from DE 43 42 185 A1.

### SUMMARY

According to an aspect of the present disclosure, a drive device of a vehicle axle is provided, in which an assembly process may be simplified compared to the prior art.

The described examples may be recited by the features of independent claims and dependent claims of the independent claims.

An aspect of the present disclosure may include a drive device for a vehicle axle in which an electric machine outputs to output shafts via a gearbox, which output shafts each lead to a vehicle wheel. In the drive device, a cylindrical stator housing of the electric machine is elongated in the axial direction by a gearbox housing. The stator housing and the gearbox housing are screwed together at a joining plane at which a stator-housing side crosses over into a gearbox-housing side. In an example, at least a first screw point between the gearbox housing and the stator housing has a threaded bolt, which is guided through a non-threaded screw hole of the gearbox housing and is in threaded engagement with an internally threaded bore formed on the stator housing. An opening edge region of the gearbox-housing screw hole may thus be braced between a bolt head of the threaded bolt and the stator housing.

In contrast to the prior art, a bolt head of the threaded bolt, which forms a tool application point, is no longer located on the stator-housing side, which contains interfering contours, but rather on the gearbox-housing side. The tool therefore accesses the threaded bolt on the gearbox-housing side, without interfering contours.

In a technical implementation, the non-threaded screw hole of the gearbox housing may lead into the gearbox-housing interior. The bolt head of the threaded bolt is thus positioned in the gearbox-housing interior in the assembled state and therefore protected from influences outside the gearbox.

In an example, the gearbox housing may be composed of two housing parts, which are arranged one behind the other in the axial direction. The two housing parts may be an intermediate housing and a housing cover. The intermediate housing is screwed directly to the stator housing, whilst the housing cover is screwed on the intermediate housing and closes the gearbox-housing interior in the axial direction.

The intermediate housing and the housing cover may be screwed together at at least a second screw point. This may likewise have a threaded bolt, which is guided through a non-threaded screw hole of the housing cover and is in threaded engagement with an internally threaded bore formed on the intermediate housing. An opening edge region of the housing-cover screw hole is thus braced between a bolt head of the threaded bolt and the intermediate thread.

With regard to automated series production, it is preferred if the joining direction of the threaded bolt at the first screw point and the threaded bolt at the second screw point are identical to one another. The internally threaded bore at the first screw point and/or at the second screw point may be formed as a blind hole with a closed bore base. Moreover, the screw axes of the first screw point and/or of the second screw point may be aligned axially parallel to the stator-housing axis.

The assembly process described below can be carried out based on the described examples: Firstly, in a providing process, a still empty stator housing may be provided and equipped with electric-machine components. The stator-housing axis here is aligned in a vertical processing direction, namely such that the joining face for connection to the gearbox housing (in particular to the intermediate housing) is positioned on the stator-housing upper side. A feed process then takes place, in which the gearbox housing (in particular the intermediate housing) is placed on the stator-housing joining face in a vertical feed motion from above. At the end of the process, a screw process is carried out, in which the threaded bolt is screwed into the screw point between the stator housing and the gearbox housing (in particular the intermediate housing) in a vertical joining direction from above.

A second feed process may then take place, in which the housing cover is placed on a corresponding intermediate-housing joining face in a vertical feed motion from above. In a subsequent screw process, a threaded bolt is screwed into the screw point between the housing cover and the intermediate housing in a vertical joining direction from above.

Therefore, in contrast to the prior art, an upending process in the prior art is no longer required to avoid an inverted screw connection, i.e. a screw connection in the joining direction from below.

### BRIEF DESCRIPTION OF DRAWINGS

The examples of the invention are described below with reference to the accompanying figures, in which:

FIG. 1 shows an electrified vehicle axle in a schematic illustration;

FIG. 2 shows an assembled drive device for the vehicle axle;

FIG. 3 shows the housing screw connections in the drive device in a detailed view;

FIGS. 4 and 5 each show views depicting an assembly process;

FIG. 6 shows a comparative prior art example in a view that may correspond to FIG. 3.

### DESCRIPTION

An electrified vehicle axle, which is equipped with an electric machine EM, is shown in FIG. 1. The electric machine EM is drivingly connected, via a two-stage transmission 1, to an axle differential 3 from which right and left output shafts 5, 7 lead to front wheels 9 of the vehicle axle. The rotor shaft 11 of the electric machine EM is coaxially connected to a gearbox input shaft 12 via an indicated torque-transmitting coupling 6 (for example, a spline). A fixed gearwheel 13, which is part of a transmission 1, is seated on the gearbox input shaft 12. The fixed gearwheel 13 of the gearbox input shaft 12 meshes with a fixed gearwheel 17 seated on an intermediate shaft 15. A further fixed gearwheel 19 of the intermediate shaft 15 meshes with an input-side outer gearwheel 21 of the front axle differential 3. The electric machine EM is aligned axially parallel to the two output shafts 5, 7.

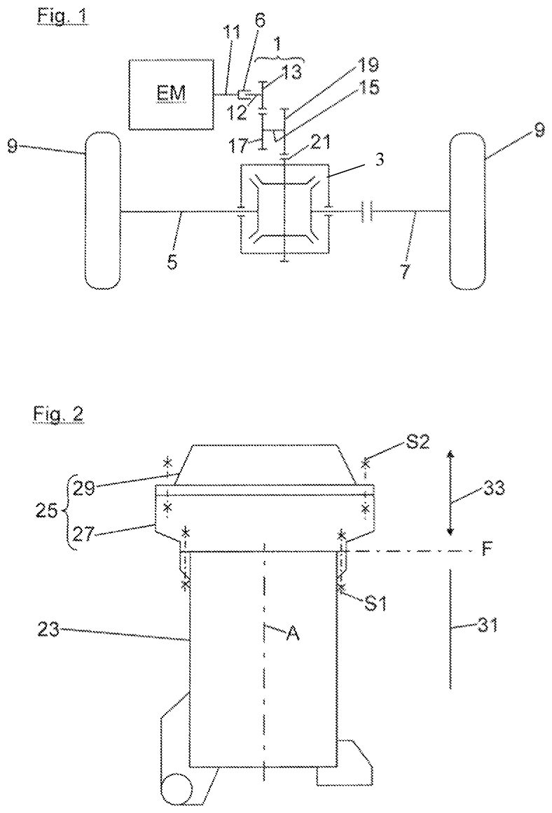

As revealed in FIG. 2, the electric machine EM has a cylindrical stator housing 23, which is elongated in the axial direction by a gearbox housing 25. Both the transmission 1 and the axle differential 3 are arranged in the gearbox housing 25. The gearbox housing 25 is composed of two parts in FIG. 2, namely an intermediate housing 27 and a housing cover 29. The intermediate housing 27 and the stator housing 23 are screwed together via first screw points S1 at a joining plane F at which (as seen in the axial direction) a stator-housing side 31 crosses over into a gearbox-housing side 33. In a similar manner, the intermediate housing 27 and the housing cover 29 are screwed together at second screw points S2.

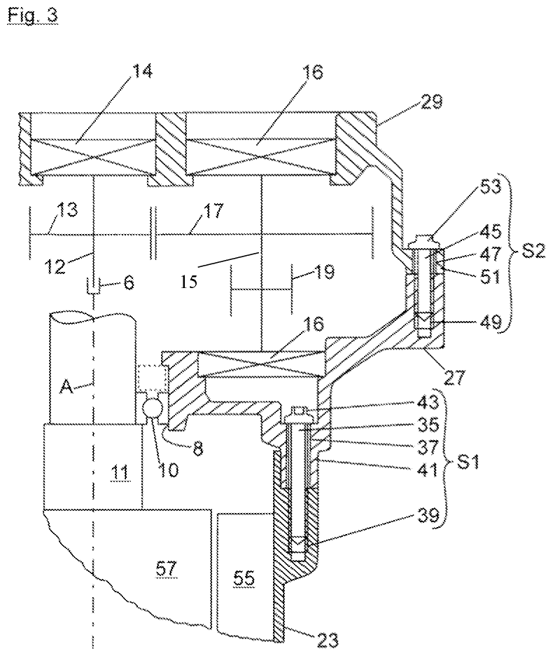

According to FIG. 3, a shaft end of the gearbox input shaft 12 is mounted in the housing cover 29 via a rotary bearing 14. The intermediate shaft 15 is rotatably mounted both in the housing cover 29 and in the intermediate housing 27 via further rotary bearings 16. The rotor shaft 11 is rotatably mounted in a bearing opening 8 of the intermediate housing 27 via a rotary bearing 10.

In the first screw point S1 shown in FIG. 3, a threaded bolt 35 is guided through a non-threaded screw hole 37 of the intermediate housing 27 and into threaded engagement with an internally threaded bore 39 formed on the stator housing 23. An opening edge region 41 of the gearbox-housing screw hole 37 is therefore braced between a bolt head 43 of the threaded bolt 35 and the stator housing 23.

In the second screw point S2 shown in FIG. 3, a threaded bolt 45 is guided through a non-threaded screw hole 47 of the housing cover 29 and into threaded engagement with an internally threaded bore 49 formed on the intermediate housing 27. An opening edge region 51 of the housing-cover screw hole 47 is braced between the bolt head 53 of the threaded bolt 45 and the intermediate housing 27.

As is further revealed in FIG. 3, the internally threaded bores 39, 49 are formed as blind holes, each with a closed bore base. The screw axes of the two screw point S1, S2 are aligned axially parallel to the stator-housing axis A. Moreover, the joining directions of the two threaded bolts 35, 45 are identical, i.e. from above in the illustrated processing position.

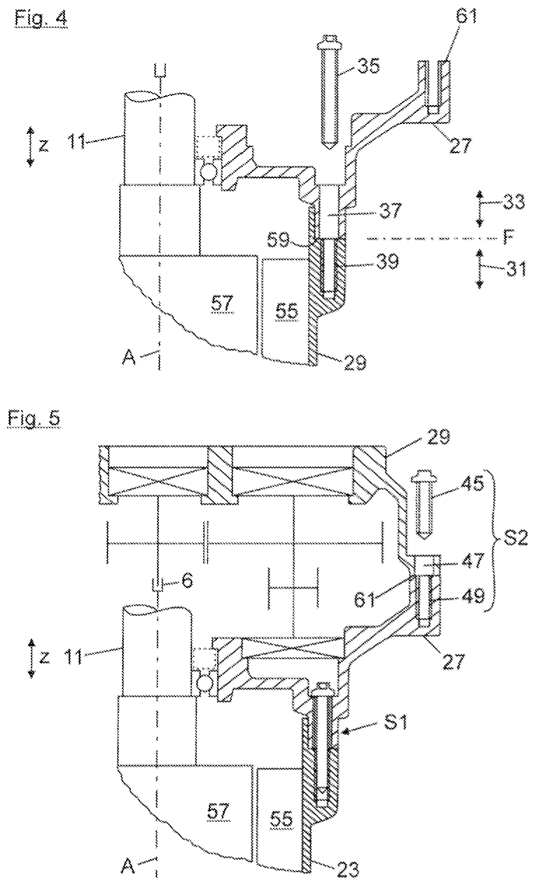

An assembly process, in which the stator housing 23, the intermediate housing 27 and the housing cover 29 are assembled in a processing station (not shown), is described below with reference to FIGS. 4 and 5: In a providing process step (not shown), the still empty stator housing 23 is provided and equipped with electric-machine components (for example a stator 55 and a rotor 57). In the providing process step, the stator housing 23 is in a processing position in which the stator-housing axis A is aligned in the vertical processing direction z (FIGS. 4 and 5). The joining faces 59 (FIG. 4) for connection to the intermediate housing 27 are therefore positioned on the stator-housing upper side.

A feed process step then takes place, in which the intermediate housing 27 is placed on the stator-housing joining faces 59 in a vertical feed motion from above. In a final screw process step (FIG. 4), the threaded bolt 35 is screwed into the screw point S1 between the stator housing 23 and the intermediate housing 27 in a vertical joining direction from above.

In a second feed step, the housing cover 29 is placed on an intermediate-housing joining face 61 (FIG. 4 or 5) in a vertical feed motion from above. In the following screw process step (FIG. 5), the threaded bolt 45 is screwed into the second screw point S2 between the intermediate housing 27 and the housing cover 29 in a vertical joining direction from above.

The joining directions of the two threaded bolts 35, 45 at the first screw point S1 and at the second screw point S2 are identical. A core feature of the examples may be in the bolt head 43 of the threaded bolt 35 being located on the gearbox-housing side 33. A tool may therefore access the bolt head 43 of the threaded bolt 35 on the gearbox-housing side 33, without interfering contours. Moreover, the bolt head 43 of the threaded bolt 35 is arranged in the housing interior.

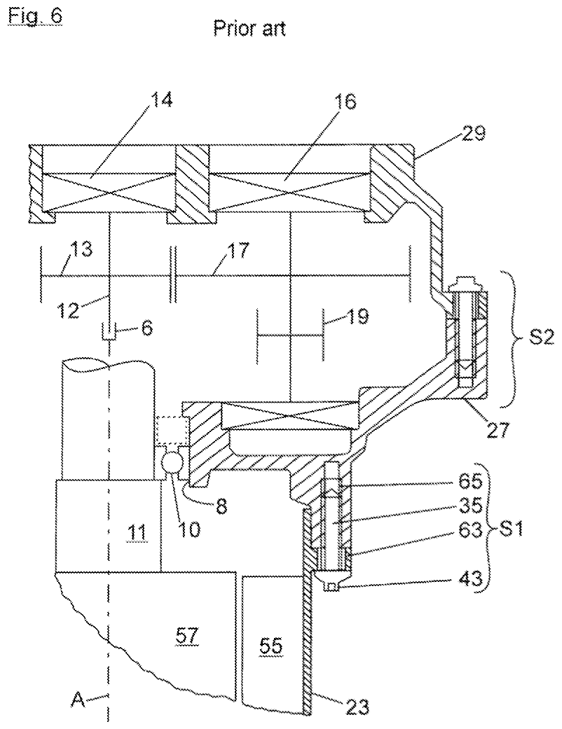

In contrast, in the comparative prior art example shown in FIG. 6, the tool is not able to access the threaded bolt 35 of the first screw point S1 in such a way without being hampered by interfering contours S1. In FIG. 6, the threaded bolt 35 is guided through a non-threaded screw hole 63 of the housing cover 23 (from below) and is in threaded engagement with an internally threaded bore 65 formed on the intermediate housing 27. An opening edge region of the non-threaded screw hole 63 is braced between the bolt head 43 of the threaded bolt 35 and the intermediate housing 27. The tool application point on the bolt head 43 of the threaded bolt 35 is not located on the gearbox-housing side 33 in FIG. 6, but on the stator-housing side 31, namely directly laterally adjacent to the outer circumference of the stator housing 23. Due to the restricted spatial conditions, the tool is not able to access the bolt head 43 of the threaded bolt 35 without being hampered by interfering contours; in this case the stator-housing outer circumference forms an interfering contour which opposes easy tool access. Moreover, to carry out the screw process step, an additional upending process step takes place, in which the stator housing 23 is upended 180°. In a subsequent feed process step, the upended stator housing 23 is arranged on the intermediate housing 27 and screw-connected there in a screw process step. The upending process step is required to avoid an inverted screw connection, i.e. a screw connection of the stator housing 23 in a joining direction from below.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

### LIST OF REFERENCE SIGNS

1 Transmission
3 Axle differential
6 Torque-transmitting coupling
7 Output shafts
8 Bearing opening
9 Vehicle wheels
10 Rotary bearing
11 Rotor shaft
12 Gearbox input shaft
13 Fixed gearwheel
14 Rotary bearing
15 Intermediate shaft
16 Further rotary bearings
17, 19 Fixed gearwheels
21 Outer gearwheel
23 Stator housing
25 Gearbox housing
27 Intermediate housing
29 Housing cover
31 Stator-housing side
33 Gearbox-housing side
35 Threaded bolt
37 Non-threaded screw hole
39 Internally threaded bore
41 Opening edge region
43 Bolt head
45 Threaded bolt
47 Non-threaded screw hole
49 Internally threaded bore
51 Opening edge region
53 Bolt head
55 Stator
57 Rotor
59 Joining faces
61 Joining faces
F Joining plane
S1 First screw point
S2 Second screw point
A Stator-housing axis
EM Electric machine

1-8. (canceled)

9. A drive device for a vehicle axle of a vehicle having an electric machine (EM) which outputs to a plurality of output shafts via a gearbox, each output shaft of the plurality of output shafts lead to a vehicle wheel, a cylindrical stator housing of the electric machine (EM) is elongated in an axial direction by a gearbox housing, the drive device comprising:
at least a first screw point between the cylindrical stator housing and the gearbox housing which in an assembled state has a threaded bolt, which is guided through a non-threaded screw hole of the gearbox housing and is in threaded engagement with an internally threaded bore formed on the cylindrical stator housing, so that the non-threaded screw hole of the gearbox housing leads into a gearbox-housing interior, and a bolt head of the threaded bolt is arranged in the gearbox-housing interior.

10. The drive device as claimed in claim 9, wherein the cylindrical stator housing and the gearbox housing are screwed together at a joining plane (F) at which a stator-housing side crosses over into a gearbox-housing side, so that a bolt head of the threaded bolt has a tool application point located on the gearbox-housing side so that a tool access to the threaded bolt is located on the gearbox-housing side.

11. The drive device as claimed in claim 9, wherein the gearbox housing is composed of two housing parts including an intermediate housing and a housing cover, which are arranged one behind each other in an axial direction, so that the intermediate housing and the housing cover which closes the gearbox-housing interior are arranged in the axial direction.

12. The drive device as claimed in claim 10, wherein the gearbox housing is composed of two housing parts including an intermediate housing and a housing cover, which are arranged one behind each other in an axial direction, so that the intermediate housing and the housing cover which closes the gearbox-housing interior are arranged in the axial direction.

13. The drive device as claimed in claim 11, wherein the intermediate housing and the housing cover are screwed together at at least a second screw point and in that the second screw point has a threaded bolt, which is guided through a non-threaded screw hole of the housing cover and is in threaded engagement with an internally threaded bore formed on the intermediate housing, so that an opening edge region of a gearbox-housing screw hole is braced between a bolt head of the threaded bolt and the intermediate housing.

14. The drive device as claimed in claim 9, wherein an internally threaded bore is formed as a blind hole with a closed bore base, and/or in that a screw axis of the first screw point and/or a screw axis of the second screw point are aligned axially parallel to a stator-housing axis (A), and/or in that a joining direction of the threaded bolt at the first screw point and the threaded bolt at the second screw point are identical.

15. A method of assembling a drive device for a vehicle axle of a vehicle having an electric machine (EM) which outputs to a plurality of output shafts via a gearbox, each output shaft of the plurality of output shafts lead to a vehicle wheel, a cylindrical stator housing of the electric machine (EM) is elongated in an axial direction by a gearbox housing, the method comprising:
a providing process in which a stator housing is provided to be equipped with electric-machine components,
aligning a stator-housing axis (A) the stator housing in a vertical processing direction (z) so that a stator-housing joining faces for connection to an intermediate housing of the gearbox housing are positioned on an upper side of the stator housing,
a feed process, in which the intermediate housing of the gearbox housing is placed on the stator-housing joining faces in a vertical feed direction from above, and
a screw process, in which a threaded bolt is screwed into a first screw point between the stator housing and the intermediate housing of the gearbox housing, in a vertical joining direction from above.

16. The method as claimed in claim 15, wherein, in a further process sequence,
there follows a second feed process step, in which the housing cover is placed on an intermediate joining faces in a vertical feed direction from above, and
a second screw process, in which a threaded bolt is screwed into a second screw point between the housing cover and the intermediate housing in the vertical joining direction from above.
